(19) United States
(12) Patent Application Publication
(10) Pub. No.: US 2019/0039524 A1
(43) Pub. Date: Feb. 7, 2019

(54) WINDING DEVICE FOR A PROTECTION DEVICE IN A PASSENGER COMPARTMENT OF A VEHICLE

(71) Applicants: Steffen RÖSCHINGER, Lorch (DE); Goran BILANDZIJA, Reichenbach (DE)

(72) Inventors: Steffen RÖSCHINGER, Lorch (DE); Goran BILANDZIJA, Reichenbach (DE)

(21) Appl. No.: 16/050,035

(22) Filed: Jul. 31, 2018

(30) Foreign Application Priority Data
Aug. 7, 2017 (DE) 10 2017 213 708.8

(51) Int. Cl. B60R 5/04; B65H 18/08; B65H 18/02

(52) U.S. Cl. CPC B60R 5/047; B65H 18/028; B65H 18/08

(57) ABSTRACT

Winding device for a protection device in an interior compartment of a vehicle having a winding shaft for windably storing a flexible planar structure. The winding shaft is rotatably supported in a supporting structure mounted fixedly to the vehicle. The winding shaft is rotatably mounted at a front end region by a bearing body on a support axle which extends co-axially to the rotational axis of said shaft and is fixedly connected to the supporting structure. The support axle extends toward a center of the winding shaft beyond the bearing body, the bearing body is axially slidably mounted on the support axle, and a position-securing sleeve is provided on the support axle and supported on the bearing body in an axially positively locking fashion and also on a radially thickened portion of the support axle.

### CROSS-REFERENCE TO RELATED APPLICATIONS

This claims priority from German Patent Application No. 10 2017 213 708.8, filed on Aug. 7, 2017, the disclosure of which is hereby incorporated by reference in its entirety.

### TECHNICAL FIELD

The invention relates to a winding device for a protection device in an interior compartment of a vehicle having a winding shaft for storing a flexible planar structure, in such a way that it can be wound up and unwound, which winding shaft is rotatably supported in a supporting structure which can be mounted fixedly to the vehicle.

### BACKGROUND

EP 2 036 773 B1 discloses a winding device for a protection device in an interior compartment of a vehicle in order to separate a cargo space from a passenger compartment. The winding device has a winding shaft which is held in a rotationally fixed fashion on a bearing bolt on both sides by means of a guiding sleeve in each case, which bearing bolt is provided on the outside with a mushroom head at an end region. The mushroom head is mounted in a receptacle fixed to the vehicle. The bearing bolt is provided with widened portions which in the event of a crash work their way into the plastic of the guide sleeve while absorbing energy, wherein in the event of a crash the guide sleeve and the bearing bolt move coaxially relative to one another.

### SUMMARY

The object of the invention is to provide a winding device of the type mentioned at the beginning which avoids parts flying around in the interior compartment of the vehicle in the event of widening the bodywork owing to a crash.

This object is achieved in that the winding shaft is rotatably mounted at at least one front end region by means of a bearing body on a support axle which extends co-axially to the rotational axis of said shaft and is fixedly connected to the supporting structure, wherein the support axle extends toward a center of the winding shaft beyond the bearing body which is mounted in an axially sliding fashion on the support axle and wherein a position-securing sleeve is provided on the support axle which is supported at one end on the bearing body in an axially positively locking fashion and at the other end on a radially thickened portion of the support axle. The at least one support axle ensures additional securement of the roller blind shaft to the supporting structure even if the supporting structure itself expands as a result of expansion caused by the bodywork. The support axle is anchored axially on the outside in a side part of the supporting structure. The materials provided for the support axle are ones which ensure sufficient strength and dimensional stability for said support axle, in particular suitable metal alloys or fiber-reinforced plastics. The radially thickened portion can be provided merely in a certain section also circumferentially in the circumferential direction and projects outward radially relative to an external lateral surface of the support axle. This prevents the roller blind shaft or other parts of the winding device from being able to fly about freely. The occupant protection is therefore improved in the case of a vehicle impact. An expansion of the vehicle bodywork occurs, in particular, in the event of a tail-end impact in which opposite lateral bodywork members of the vehicle bodywork are deformed laterally toward the outside. The solution according to the invention is suitable for a protection device in the region of a cargo space of the motor vehicle, in particular in the form of a cargo space cover, in the form of a separating device which separates the cargo space from a passenger compartment or else in the form of a protection device for shading side windows or rear windows of the motor vehicle or finally for shading a glass roof region of the motor vehicle. The position-securing sleeve can be configured from plastic or from metal, in particular in the form of a hose or tube, preferably as a sheet-metal sleeve, as a metal mesh hose, as a flexible plastic hose, as a largely dimensionally stable plastic hollow profile with round or polygonal cross section or the like.

In one refinement of the invention, the support axle is configured as a steel axle and is held in a positively locking fashion in a side part of the supporting structure. The support axle is accordingly not connected to a vehicle-side receptacle but merely to the supporting structure itself. The positively locking attachment of the support axle in the side part of the supporting structure forms an end-side anchoring means of the support axle and ensures a high force-transmission function, ensuring that the support axle remains connected to the side part of the supporting structure even in a crash situation.

In a further refinement of the invention, the radially thickened portion is configured as a mushroom head which is integrally formed on an end region of the support axle. This is a particularly simple and functionally reliable configuration. Alternatively, the radially thickened portion can be formed by a separate component, in particular in the manner of a mushroom head which is fixedly connected to the end region of the support axle. The separate component can, in particular, be screwed into the end region of the support axle.

In a further refinement of the invention, the position-securing sleeve is configured as a plastic sleeve which is fitted axially onto the support axle, wherein an internal diameter of the plastic sleeve corresponds at least largely to an external diameter of the support axle. The support axle is positioned in a stationary fashion relative to the supporting structure, and the at least one bearing body is rotatably mounted on the support axle. The plastic sleeve can be configured in the form of a hose or tube and forms an axial support of the bearing body and consequently a position-securing means of the bearing body—viewed coaxially with respect to the rotational axis of the bearing body. The plastic sleeve can be configured in an elastically flexible fashion in the manner of a hose or a dimensionally stable fashion in the manner of a tube. If the support axle is configured in a cylindrical fashion, an internal lateral surface of the plastic sleeve is also configured in a cylindrical fashion. If the support axle has a polygonal cross section, the internal circumference of the plastic sleeve is also provided with a correspondingly polygonal cross section.

### BRIEF DESCRIPTION OF THE DRAWINGS

Further advantages and features of the invention can be found in the claims as well as in the following description of a preferred exemplary embodiment of the invention which is illustrated in the drawings, in which:

FIG. 1 shows a perspective illustration of a cargo space of a motor vehicle within an interior compartment of a vehicle with an embodiment of a winding device according to the invention,

FIG. 2 shows the illustration according to FIG. 1 with a flexible planar structure which is moved into a protection position,

FIG. 3 shows an enlarged illustration of a detail of the winding device according to FIGS. 1 and 2, omitting the flexible planar structure,

FIG. 4 shows the illustration according to FIG. 3 with a winding shaft omitted,

FIG. 5 shows the illustration according to FIG. 4 with a bearing body which has been displaced in accordance with a crash state,

FIG. 6 shows a perspective illustration of part of a supporting structure of the winding device according to FIGS. 3 to 5, and

FIG. 7 shows a side view of the supporting structure according to FIG. 6.

### DETAILED DESCRIPTION

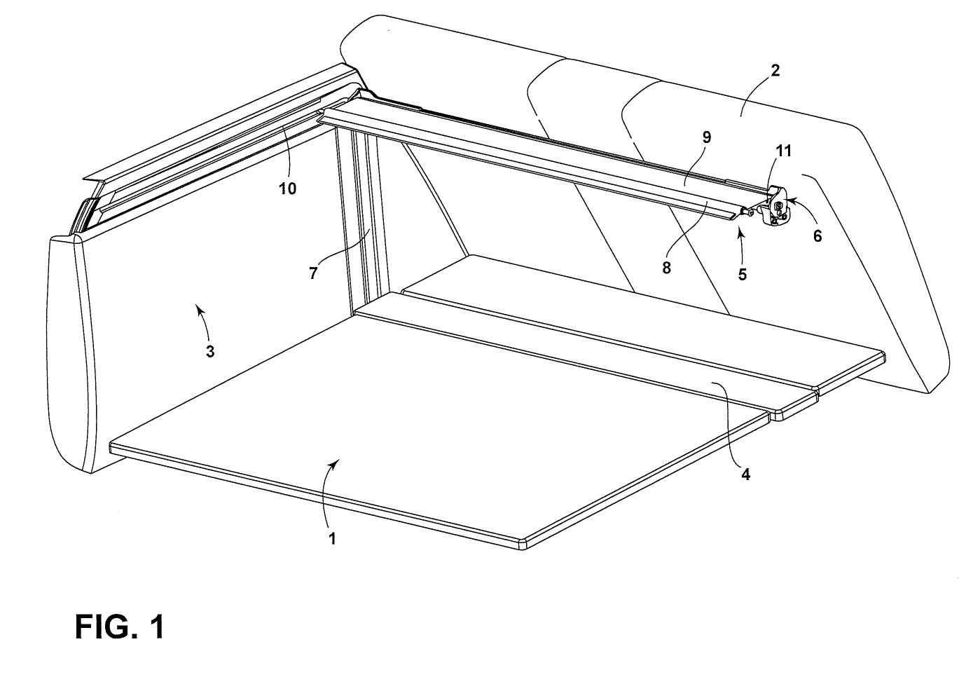

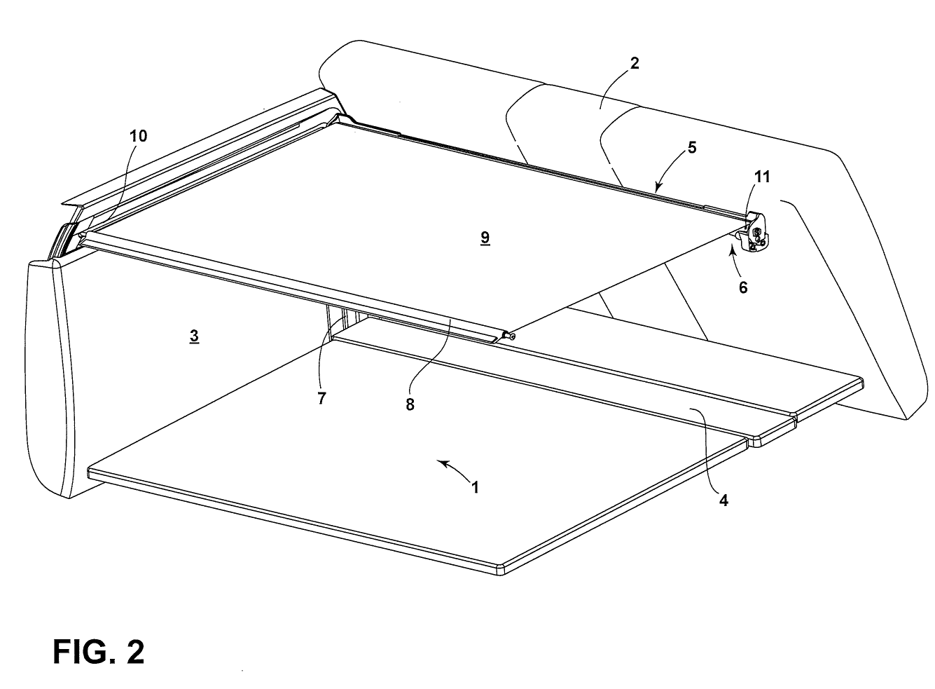

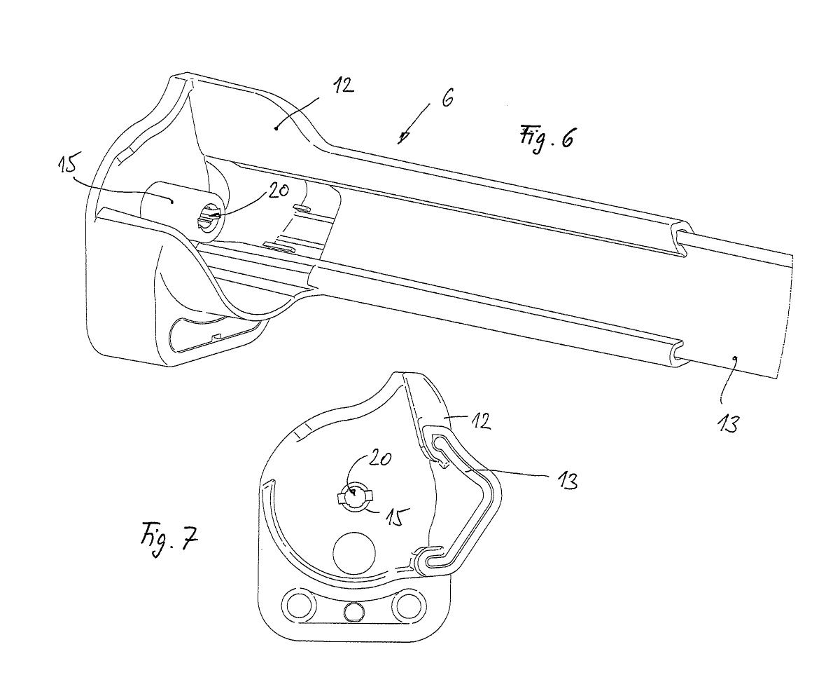

A passenger motor vehicle, has, according to FIGS. 1 and 2, an interior compartment of a vehicle which is provided, behind a rear seat bench 2, with a cargo space 1. The cargo space 1 is bounded on opposite sides by one side wall 3 in each case. Toward the rear, the cargo space 1 is bounded by a movable bodywork part in the form of a tail gate which is not illustrated. The cargo space 1 is assigned a protection device in the form of a cargo space cover which has a flexible planar structure in the form of a covering sheet 9. The covering sheet 9 is stored in such a way that it can be wound up and unwound by means of a winding device 5 which is explained in more detail with reference to FIGS. 3 to 7. The winding device 5 has a supporting structure 6 which extends in the transverse direction of the vehicle and in which a winding shaft 11 is rotatably mounted in a manner which is described in more detail below. The covering sheet 9 is held in such a way that it can be wound and unwound on the winding shaft 11. The cover sheet 9 can be extended and retracted between a position of rest in which it is wound onto the winding shaft 11 and a protection position (FIG. 2) in which it is extended approximately horizontally with respect to a rear region of the cargo space 1. For this purpose, the cover sheet 9 has, at its front end region in the extraction direction, a dimensionally stable extraction profile 8 which projects, at its opposite end sides, into, in each case, one guide track 10 of the respective side wall 3 of the cargo space 1 with the aid of guide pins. In the position of rest of the cover sheet 9, the extraction profile 8 is stored in the supporting structure 6. The guide pins of the extraction profile 8 are not connected to the guide tracks 10 in the position of rest of the cover sheet 9.

The cargo space cover 5 can be displaced between an out-of-use position and a functional position, in a vertical direction of the vehicle within the cargo space 1. For this purpose, a depression which can be closed by a cover 4 is provided in a cargo space floor. The cargo space cover is arranged countersunk in the depression and covered by the cover 4 as long as the cargo space cover is not required. In order to displace the cargo space cover 5 in the vertical direction of the vehicle between the out-of-use position use and the functional position the supporting structure 6 is anchored at its opposite end regions by means of, in each case, a guide carriage, in, in each case, a guide rail 7 which is fixed to the vehicle and extends in a vertical direction of the vehicle. In order to displace the cargo space cover 5 between the out-of-use position and the functional position a drive is provided which is not illustrated in the drawings. The two guide carriages in the opposite guide rails 7 of the cargo space 1 are connected fixedly in the event of a crash to the respective end regions of the supporting structure 6 of the cargo space cover 5, with the result that the supporting structure 6 remains connected to the guide carriages in the guide rails 7 even in the case of a vehicle impact which gives rise to the lateral expansion of a vehicle bodywork in the region of the side walls 3.

The supporting structure 6 has, according to FIGS. 3 to 7, in each case a dimensionally stable side part 12 at the opposite side regions, which side part 12 is connected in each case at the end side fixedly with respect to a crash to the guide carriage (not illustrated) as soon as the supporting structure 6 is mounted in an operationally ready fashion. The two side parts 12 have, on a rear side facing the rear seat bench 2, a guide profile section which extends in the transverse direction of the vehicle and into which a center part 13 is inserted. The center part 13 is configured as a simple shell profile and is plugged in the transverse direction of the vehicle into corresponding groove sections of the respective guide section of the respective side part 12 and can be slid relatively to these guide sections. For the center part 13 is held in a linearly movable fashion in the transverse direction of the vehicle at the respective guide section of the respective side part 12, but can be additionally connected to one of the two guide sections of the respective side part 12 by a securing screw.

In order to support the winding shaft 11 in the supporting structure 6, the winding shaft 11 is provided at each of its opposite end sides with a bearing body 14 which is inserted into the respective open end side of the winding shaft 11 which is configured as a hollow profile. The two bearing bodies 14 are connected in a rotationally fixed fashion to the opposite end regions of the winding shaft 11.

The two side parts 12, only one of which is illustrated in FIGS. 3 to 7, are each provided at their end sides with a bearing dome 15 which protrudes inwardly coaxially with respect to a rotational axis of the winding shaft 11 and in which dome in each case a support axle 17 is positioned in a rotationally fixed and axially secured fashion. For this purpose, the respective bearing dome 15 has a slotted receptacle into which the support axle 17 is plugged with cams which project radially in a complementary fashion and is attached there both in a rotationally secured and axially secured fashion. The respective support axle 17 projects coaxially with respect to the rotational axis of the winding shaft 11 toward a center of the supporting structure 6. In the illustrated exemplary embodiment, the support axle 17 is embodied as an essentially cylindrical steel axle, wherein the cams for rotational securement in the bearing dome 15 are formed by corresponding stamped elements. The support axis 17 has at its end which protrudes from the bearing dome 15 a radially thickened portion in the form of a collar 19. The collar 19 can be integrally formed onto the end of the support axle 17 or, according to another embodiment, can be inserted as a separate pin component into an end-side opening in the support axle 17. A diameter of the collar 19 is greater than a diameter of the support axle 17. The pin component can be provided with an external thread and the opening in the end side of the support axle 17 can be provided with a complementary internal thread. Alternatively, the pin component can be held in the opening of the support axle 17 by means of a press fit.

The respective bearing body 14 is rotatably mounted on a cylindrical part of the support axle 17 so that the support axle 17 forms a rotary bearing for the respective bearing body 14. The winding shaft 11 is consequently rotatably mounted on the two support axles 17, projecting inward coaxially with respect to one another, of the opposite side parts 12.

The center part 13 and the two side parts 12 are mounted so as to be slidable in a linear moveable fashion relative to one another in the transverse direction of the vehicle. In this context, the center part 13 can be connected to one of the two side parts 12 via the securing screw described above. The other side part 12 is, however, connected to the center part 13 in a longitudinally slidable fashion with the result that the two side parts 12 are mounted so as to be movable relative to one another and coaxially with respect to the rotational axis of the winding shaft 11 in the manner of a floating bearing.

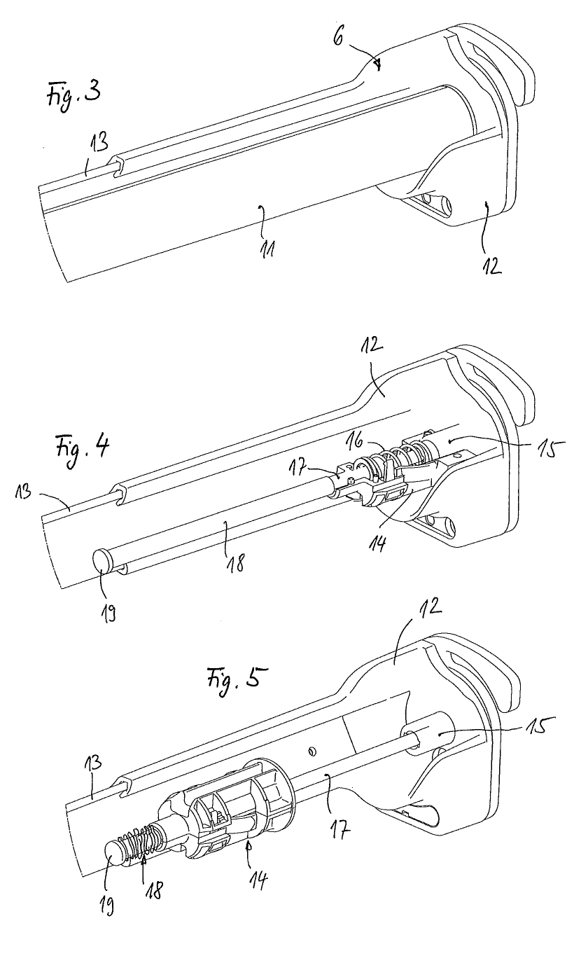

In each bearing body 14 a compression spring 16 is provided which is supported axially toward the center, i.e. in the direction of the collar 19 of the support axle 17, on a stop collar within the bearing body 14 and which is supported on an end face of the bearing dome 15 while facing the outside, i.e. the end side of the side part 12. As a result, a compression force is permanently applied outward on the respective side part 12 coaxially with respect to the rotational axis of the winding shaft 11 with the result that force is applied outward to the two side parts 12 in opposition to one another, in the transverse direction of the vehicle. The respective bearing body 14 is mounted both in a rotationally and axially movable fashion on the respective support axle 17. In order to avoid a situation in which before installation in the motor vehicle the compression force of the compression spring 16 pushes outward, as a result of which the support axle 17 would also be slid outward coaxially within the bearing body 14 until the bearing body 14 impacts against the collar 19, a position-securing sleeve 18 is provided between an end collar of the bearing body 14 and the collar 19. The position-securing sleeve 18 is supported inwardly at the end on the collar 19 of the support axle 17 toward the center of the supporting structure 6 and outwardly at the end on the end collar of the bearing body 14, as can be seen from FIG. 4. The position-securing sleeve is composed of plastic and is configured in the form of a hose or tube. In the illustrated exemplary embodiment, the position-securing sleeve 18 has a hollow-cylindrical shape, wherein an internal diameter is configured in such a way that the position-securing sleeve 18 can be fitted axially onto the support axle 17. In this context, initially the support axle 17 is mounted in the bearing dome 15 of the side part 12 with the collar 19 still removed. The bearing body 14 is subsequently fitted onto the support axle 17. The position-securing sleeve 18 is then fitted on axially and presses the bearing body 14 with prestress of the compression spring 16 against the end face of the bearing dome 15. Finally, the collar 19 which secures the position-securing sleeve 18 axially in a positively locking fashion on the support axle 17 is mounted. In a further mounting step, the hollow profile of the winding shaft 11 is plugged coaxially onto the bearing body 14. At the same time, the center part 13 is inserted into the guide sections of the side parts 12. The winding device which is mounted in this way is then connected to the guide carriages in the region of the guide rails 7 of the cargo space 1.

As soon as the two side parts 12 are pulled outward owing to a vehicle impact which gives rise to expansion of the opposite side walls 3 of the cargo space, the position-securing sleeve 18 is, according to FIG. 5, necessarily buckled and compressed in a compact fashion. In this context, a certain degree of energy absorption takes place. However, the bearing bodies 14 remain connected to the respective support axle 17 owing to the axle securement by the respective collar 19, with the result that in such a crash situation the winding shaft 11 and/or the bearing bodies 14 cannot become detached from the supporting structure 6 and therefore also cannot fly around in the interior compartment of the vehicle.

1. Winding device for a protection device in an interior compartment of a vehicle having a winding shaft for storing a flexible planar structure, in such a way that it can be wound up and unwound, which winding shaft is rotatably supported in a supporting structure which can be mounted fixedly to the vehicle, wherein the winding shaft is rotatably mounted at at least one front end region by means of a bearing body on a support axle which extends co-axially to the rotational axis of said shaft and is fixedly connected to the supporting structure, wherein the support axle extends toward a center of the winding shaft beyond the bearing body which is mounted in an axially sliding fashion on the support axle, and wherein a position-securing sleeve is provided on the support axle which is supported at one end on the bearing body in an axially positively locking fashion and at the other end on a radially thickened portion of the support axle.

2. Winding device according to claim 1, wherein the support axle is configured as a steel axle and is held in a positively locking fashion in a side part of the supporting structure.

3. Winding device according to claim 1, wherein the radially thickened portion is configured as a mushroom head which is integrally formed on an end region of the support axle.

4. Winding device according to claim 1, wherein the position-securing sleeve is configured as a plastic sleeve which is fitted axially onto the support axle, wherein, in particular, an internal diameter of the plastic sleeve corresponds at least largely to an external diameter of the support axle.

5. Winding device according to claim 1, wherein a compression spring which applies a permanent pressure loading to the side part coaxially with respect to the rotational axis of the winding shaft is integrated into the bearing body.
